(19) United States
(12) Patent Application Publication
(10) Pub. No.: US 2008/0301467 A1
(43) Pub. Date: Dec. 4, 2008

(54) Memory Security Device

(75) Inventor: Seiichiro Saito, Kanagawa-ken (JP)

Correspondence Address: SPRINKLE IP LAW GROUP, 1301 W. 25TH STREET, SUITE 408, AUSTIN, TX, 78705, US

(73) Assignee: Kabushiki Kaisha Toshiba, Tokyo (JP)

(21) Appl. No.: 12/128,322

(22) Filed: May 28, 2008

(30) Foreign Application Priority Data
May 31, 2007 (JP) P2007-145265

(51) Int. Cl. G06F 12/14

(52) U.S. Cl. 713/190

(57) ABSTRACT

Embodiments of the systems and methods presented herein may provide memory security in a semiconductor device or a computing system using an address encryption section operable to encrypt a write address or a read address, a data encrypting section operable to encrypt data to be written, a write section operable to write encrypted data at an encrypted write address corresponding to a memory, a read section operable to read encrypted data from the encrypted read address corresponding to the memory and a data decryption section operable to decrypt the read encrypted data to obtain read data corresponding to the read address.

### CROSS-REFERENCE TO RELATED APPLICATIONS

This application claims the benefit of priority to Japanese Patent Application No. P2007-145265, entitled “Memory Security Device”, filed May 31, 2007 by inventor Seiichiro Saito, the entire contents of which is hereby incorporated by reference.

### BACKGROUND

1. Field of the Invention

The present invention relates to a memory security system for protecting data stored in a memory.

2. Description of the Related Art

In a confidential information managing device 100 disclosed in Japanese Patent Application Publication No. 2006-129340, when confidential information is going to be archived to be unused for a long time, a random number generator 1021 generates a random number; an encryptor 1022 encrypts (or conceals) the confidential information by using the random number as an encryption key, and stores the confidential information thus encrypted in a memory 101; and thereafter, a transmitter 105 transmits the encryption key to an external information management device, and lets the external information management device to manage the encryption key. In addition, in the confidential information management device 100 disclosed in the same patent document, when the confidential information is going to be used, a receiver 106 receives the encryption key from the external information management device, and a decryptor 1041 decrypts (or recovers) the encrypted confidential information, which has been stored in the memory 101, by using the received encryption key as a decryption key.

Japanese Patent Application Publication No. 2006-023957 has disclosed a technique in which data to be stored in an external memory 4 is encrypted depending on what storage location in the external memory 4 the data is stored in. Even if, for example, a third party copies the encrypted data from the external memory 4 to a storage medium, the third party cannot decrypt the copied encrypted data without knowing what storage location in the external memory 4 the encrypted data has been originally stored.

A system disclosed in Japanese Patent Application Publication No. 2005-301339 encrypts user's own data and the serial number of its storage medium, and stores the encrypted user's own data and serial number in the storage medium. When the storage medium is going to be used, the system decrypts the encrypted user's own data and serial number to judge whether use of the storage medium is unauthorized. When it is judged that the use of the medium is unauthorized, the system enables a request to stop operation of the medium. Thereby, the system prevents unauthorized use of data stored in the medium.

Generally speaking, in the case where, for example, a chip (for example, a slave device) is connected to a certain device (for example, a host) and where a memory of the chip is also an external chip, the chip itself prevents code or data stored in the memory from being improperly acquired or manipulated by use of its function of restricting an access from the device in a normal use mode.

### SUMMARY

Despite such a memory security scheme, in some cases, the contents in this memory can be read, when the power supply to the external memory continues even while the power supply to the chip is cut off due to the power saving function, or when a person skilled in reverse engineering intentionally makes arrangements for supplying power only to the memory while powering off the chip.

The present invention has been made with the foregoing cases taken into consideration. An object of the present invention is to provide a memory security device for preventing unauthorized acquisition and manipulation of data in a discrete memory.

The foregoing problem is solved by a memory security block including an address encryption section operable to encrypt a write address or a read address, a data encrypting section operable to encrypt data to be written, a write section operable to write encrypted data at an encrypted write address corresponding to a memory, a read section operable to read encrypted data from the encrypted read address corresponding to the memory and a data decryption section operable to decrypt the read encrypted data to obtain read data corresponding to the read address.

Embodiments of these solutions may also be utilized in a computer system for use with digital television which may include a multi-processor unit operable to decode compressed first data, generate second data from the first data and encode the second data to generate compressed second data, a memory/processor controller operable to receive third data and store the third data in a first memory, the memory/processor controller having a memory security block, the memory security block comprising: an address encryption section operable to encrypt a write address or a read address, a data encrypting section operable to encrypt data to be written, a write section operable to write encrypted data at an encrypted write address corresponding to the first memory, a read section operable to read encrypted data from the encrypted read address corresponding to the first memory and a data decryption section operable to decrypt the read encrypted data to obtain read data corresponding to the read address. The computer system may further include a central processing unit coupled to the memory/processor controller, an I/O unit coupled to one or more devices and operable to receive data operable to receive data from one or more devices, a multi-processor unit and a memory/processor controller and communicate data to the one or more devices, the multi-processor unit and the memory/processor controller.

Embodiments of the present invention make it possible to prevent unauthorized acquisition and manipulation of data in a discrete memory.

### BRIEF DESCRIPTION OF THE DRAWINGS

FIG. 1 is a block diagram showing an example of a memory security device according to a first embodiment of the present invention.

FIG. 2 is a block diagram showing an example of how the device restricts access to a memory from a host

FIG. 3 is a block diagram showing an example of how access restriction is released by use of a crack code.

FIG. 4 is a block diagram showing an example of how data is protected by the memory security device according to the first embodiment.

FIG. 5 is a block diagram showing an example of how the memory security device according to the first embodiment performs a shuffle process to an address.

FIG. 6 is a block diagram showing an example of how the memory security device according to the first embodiment performs a shuffle process to write data.

FIG. 7 is a block diagram showing an example of a multi-processor provided with a memory security device according to a second embodiment of the present invention.

FIG. 8 is a block diagram showing an example of an application of the multi-processor according to the second embodiment.

FIG. 9 is a block diagram showing an example of a multi-processor provided with a memory security device according to a third embodiment of the present invention.

### DETAILED DESCRIPTION OF EXEMPLARY EMBODIMENT

Descriptions will be provided hereinbelow for the embodiments of the present invention by referring to the drawings. It should be noted that, in the following drawings, components implementing the same or similar functions will be denoted by the same reference numerals.

### First Embodiment

In the case of the present embodiment, descriptions will be provided for a memory security device having a function of converting the contents of data which is going to be stored in a memory, and thereafter of shuffling the storage location of the converted data.

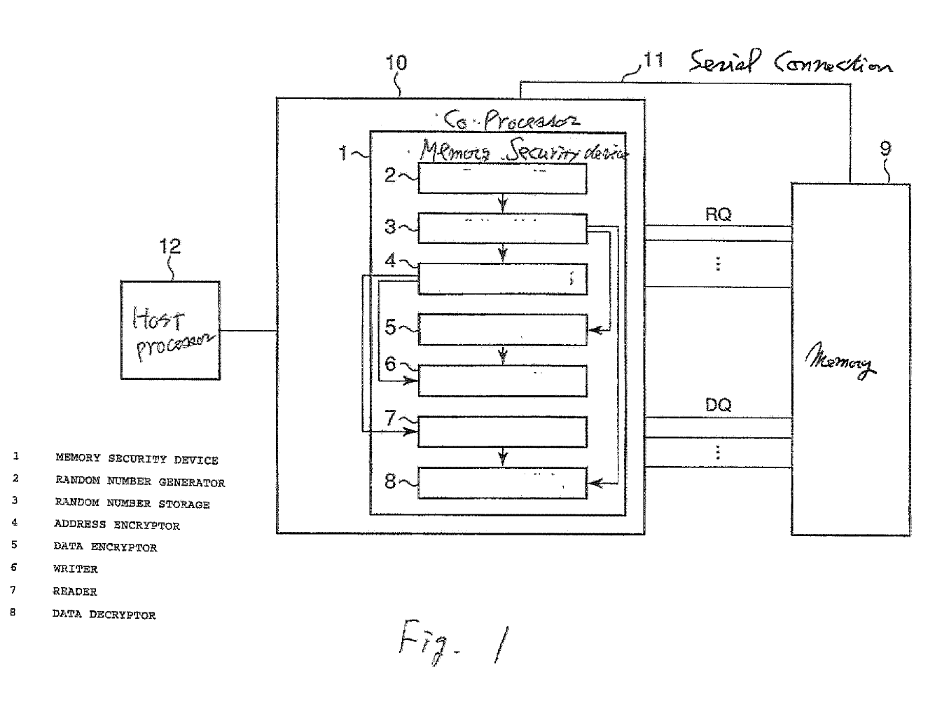

FIG. 1 is a block diagram showing an example of the memory security device according to the present embodiment.

A memory security device 1 according to the present embodiment includes a random number generator 2, a random number storage (register) 3, an address encryptor 4, a data encryptor 5, a writer 6, a reader 7, and a data decryptor 8.

It is assumed, in the present embodiment, that a memory 9 and a device (for example, a memory controller, a memory interface and the like) 10 are different chips, and that the memory security device 1 is included in the device 10.

The memory 9 and the device 10 are connected to each other via a buss RQ, a buss DQ, and a serial connection 11. The bus RQ is used for transferring requests between the device 10 and the memory 9. The bus DQ is used for transferring data between the device 10 and the memory 9. The serial connection 11 is used for transferring test data, initialization data, and debug data between the device 10 and the memory 9.

A host device 12 writes data in the memory 9, and reads data from the memory 9, by use of the device 10.

In the case of the present embodiment, the random number generator 2 in the memory security device 1 generates random numbers including a random number for address and a random number for data, and stores the random numbers in the random number storage 3. The memory security device 1 adopts a configuration which makes it impossible for the random numbers, which have been generated by the random number generator 2, and which are stored in the random number storage 3, to be read from the outside of the memory security device 1.

When date is going to be written in the memory 9, the address encryptor 4 XORs a write address by use of the random number for address which is stored in the random number storage 3, and thus creates an encrypted write address.

In addition, when data is going to be read from the memory 9, the address encryptor 4 XORs a read address by use of the random number for address which is stored in the random number storage 3, and thus creates an encrypted read address.

When data is going to be written in the memory 9, the data encryptor 5 XORs a write data by use of the random number for data which is stored in the random number storage 3, and thus creates an encrypted write data.

The writer 6 writes, in the memory 9, the encrypted write data, which has been created by the data encryptor 5, in an area indicated by the encrypted write address, which has been created by the address encryptor 4.

The reader 7 reads, from the memory, encrypted read data from an area indicated by the encrypted read address, which has been created by the address encryptor 4.

The data decryptor 8 XORs the encrypted read data read by the reader 7, by use of the random number for data, which is stored in the random number storage 3, and thus creates read data corresponding to the read address.

The memory security device 1 according to the present embodiment causes the built-in random number generator 2 to generate new random numbers, and thus to replace old random numbers with the new random numbers, each time the memory security device 1 is activated. The random numbers include a random number for address and a random number for data, and are stored in the random number storage 3.

After that, the random number for address and the random number for data, which are stored in the random number storage 3, are used until a reset instruction is inputted to the device 10.

The random number for address is used for shuffling the addresses, and the random number for data is used for scrambling the data.

Each time the memory security device 1 is activated, the random number generator 2 is designed to change random numbers (seeds). As a result, the post-reset random numbers are not equal to the pre-reset random numbers. Neither the random number for address nor the random number for data can be read from the outside of the memory security device 1. No value can be set up in the random number storage 3 from devices other than the random number generator 2.

Descriptions will be provided hereinbelow for a concept of how data is protected by the memory security device 1 according to the present embodiment.

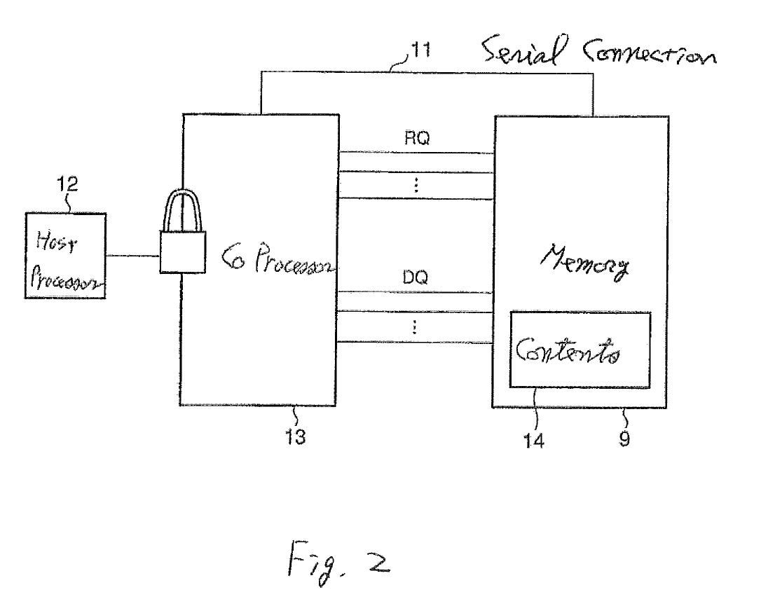

As shown in FIG. 2, in a case where a normal restriction is imposed on access to the memory 9, a device 13 restricts access to the memory 9 from the host device 12, and thus allows no direct access to the memory 9, where contents 14 (for example, firmware, various programs, and data) which a user wishes to protect are stored. In general, access restriction can be turned on or off from inside the device 13.

Even while, however, a restriction is being imposed on the access to memory 9, exploitation of the serial IO (input/output) function of the memory 9 or the like enables a direct write in the memory 9.

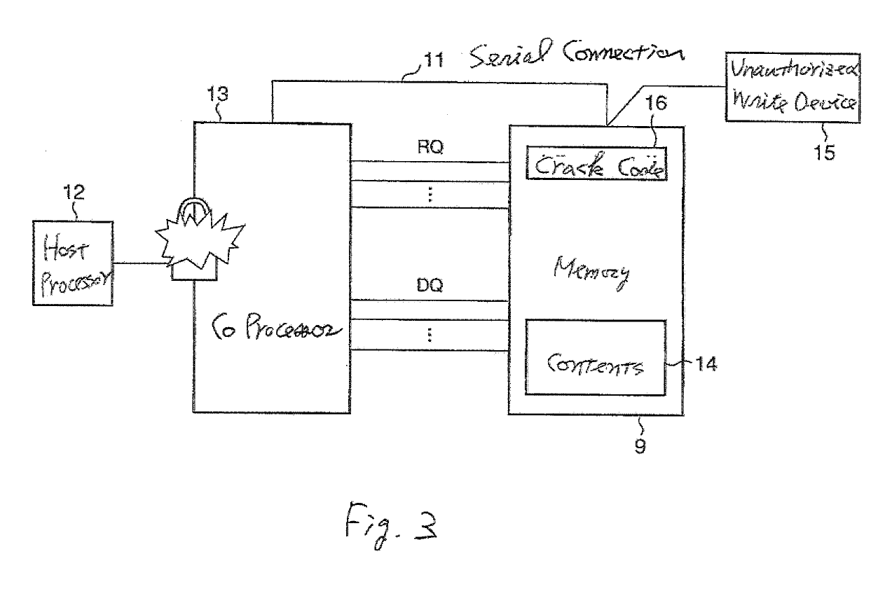

Use of this kind of characteristic enables an attack scheme in which, as shown in FIG. 3, a crack code 16 including a code for releasing the access restriction is directly written in the memory 9 by use of an unauthorized write device 15 through exploitation of a buffer overflow, buffer overrun, or the like, and this direct write accordingly causes the access restriction inside the device 13 to be released (or this direct write accordingly causes the device 13 to execute the crack code 16). Once the crack code 16 is executed by the device 13, the host device 12 can access the contents 14 on which the access restriction has been imposed.

The present embodiment employs a scheme for protection against this type of attack. According to this scheme, the write data is shuffled, and the storage location of the write data in the memory 9 is also shuffled. This double-shuffling prevents the device 10 from executing a crack code 16 written in the memory 9 through the exploitation of the serial IO function.

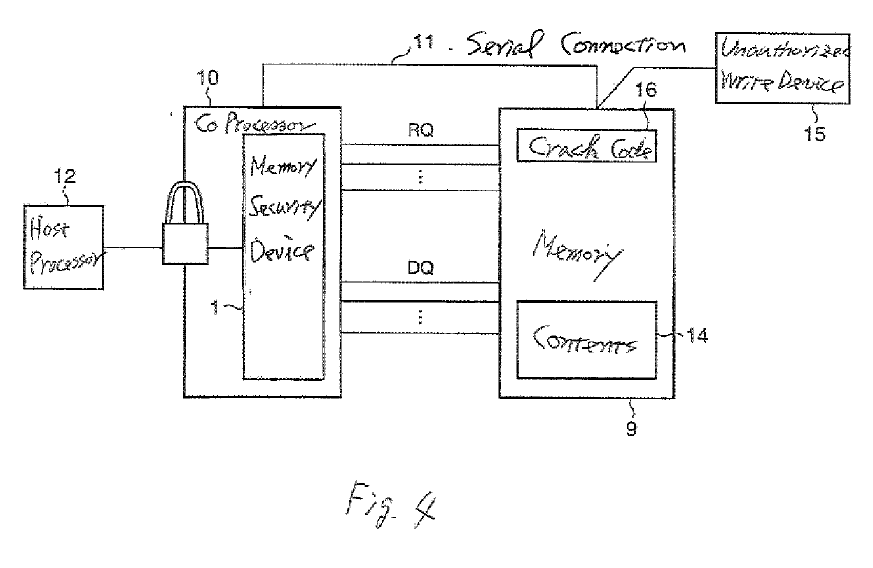

FIG. 4 is a block diagram showing an example of how data is protected by the memory security device 1 according to the present embodiment.

In the example shown in FIG. 4, the device 10 writes the address and data, as they are in shuffle mode, in the memory 9. Furthermore, the device 10 reads the shuffled data from the memory 9 in which the address and data are stored in the shuffle mode, and converts the shuffled data to the pre-shuffled data.

Assume here that, for example, the crack code 16 is written in the memory 9 by the unauthorized write device 15 through the exploitation of the buffer overflow, buffer overrun, or the like.

In this case, even if the crack code 16 is read by the device 10, the data decryptor 8 XORs, by use of a random number, the crack code 16 thus read. As a result, the crack code 16 functions no longer.

This makes it possible to prevent the unauthorized acquisition of the contents 14 requiring protection, which acquisition would otherwise be made by use of the crack code 16.

Moreover, in the memory 9, the storage location and contents of the contents 14 are in shuffle mode since the address and the data are encrypted. For this reason, even if the contents stored in the memory 9 can be read, the contents 14 can be protected.

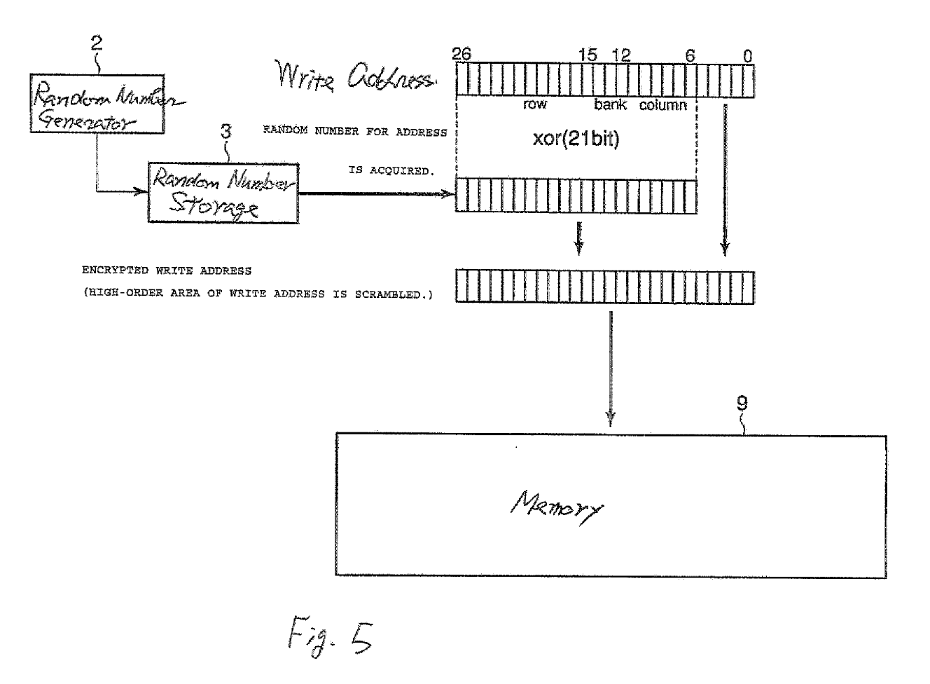

FIG. 5 is a diagram showing an example of how an address is shuffled by the memory security device 1 according to the present embodiment. Although FIG. 5 only shows how the write address is shuffled, the read address is shuffled in the same manner as the write address is shuffled.

Once the write address for the write data is issued, the random number generator 2 generates a random number. The random number storage 3 then stores the random number.

In the case of the present embodiment, out of 36 bits contained in the random number generated, particular 21 bits are used as a random number for address when the address encryptor XORs the write address. By use of the random number for address, the address encryptor XORs a high-order area including areas for a row, bank, column, and the like out of the write address. Thereby, an encrypted write address is created.

The encrypted write data is written in the memory 9 in accordance not with the write address, but with the encrypted write address.

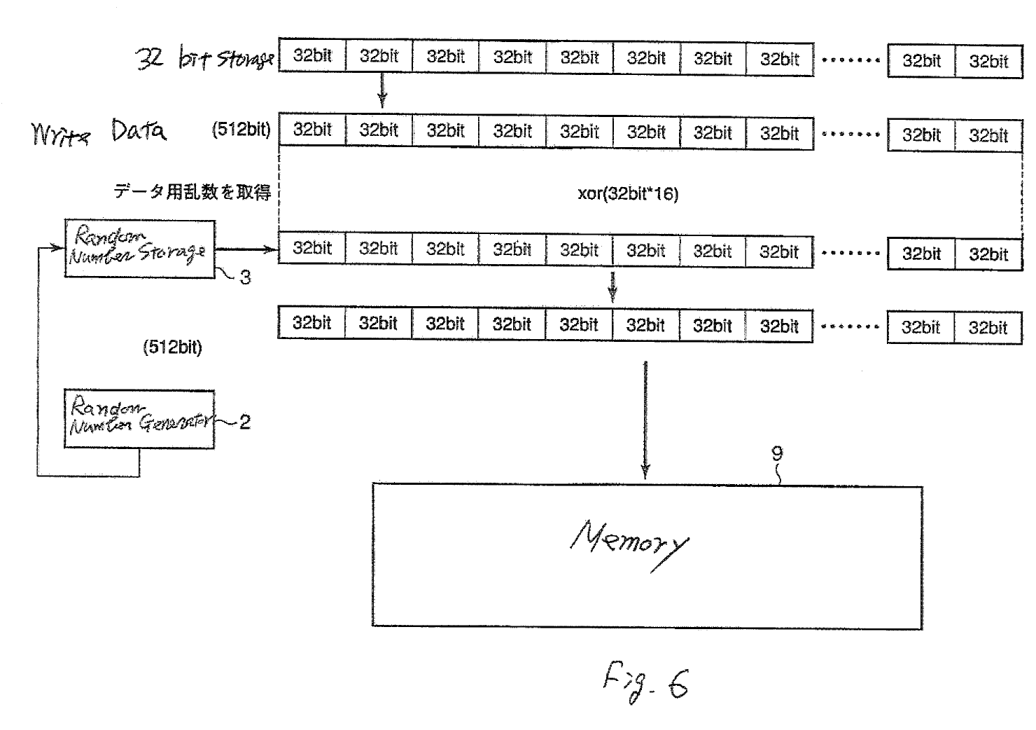

FIG. 6 is a diagram showing an example of how write data is shuffled by the memory security device 1 according to the present embodiment.

The random number generator 2 generates a 32-bit random number, and this random number is used as a random number for data when the data encryptor XORs the write data. A unit for which the data encryptor XORs the write data is set at 32 bits. In other words, the data encryptor XORs each 32 bits of the write data by use of the same random number for data.

FIG. 6 shows how the write data is shuffled. The read data is decrypted in the same manner as the write data is shuffled. For example, the memory security device 1 fetches the encrypted read data for each 512 bits from the external memory chip, and XORs each 32 bits of the encrypted read data by use of the random number for data. Thereby, pre-scrambled 512-bit read data is obtained. In this manner, the memory security device 1 XORs the encrypted read data (32 bits×16 units) by use of the same random number consisting of 32 bits.

The memory security device 1 XORs both the address and the data in each of the cases of writing data and reading data. For this reason, the system can obtain the same values.

In the present embodiment, as described above, a location where instruction strings and the like included in the contents 14 are stored in the memory 9 is changed each time the memory security device 1 is activated. Accordingly, the present embodiment makes it possible to prevent a specific location in the memory 9 from being attacked. Furthermore, in the present invention, the device 10 decrypts the read data. Accordingly, even if the crack code 16 is written in the memory 9, the present embodiment makes it possible to prevent the crack code 16 from being executed by the device 10, and thus to prevent the access restriction from being released.

In other words, even in the case where something is written in the memory 9 through the exploitation of the serial TO function, the present embodiment makes it possible to nullify the contents and the location of what is written in the memory 9 and the location where the contents are invalidly written therein, and thus makes it difficult to manipulate the memory 9.

The present embodiment employs the encrypting and decrypting schemes in which the random numbers are generated and the XOR operations are performed by use of the random numbers. However, other encrypting and decrypting schemes can be employed. For example, various reversible conversion schemes can be employed. In addition, irreversible conversion schemes can be employed for encrypting the write data, and for decrypting the encrypted read data. Different schemes may be used for encrypting the data and for encrypting the address.

### Second Embodiment

In the present embodiment, descriptions will be provided for a case where the memory security device 1 according to the first embodiment is employed in a multi-processor.

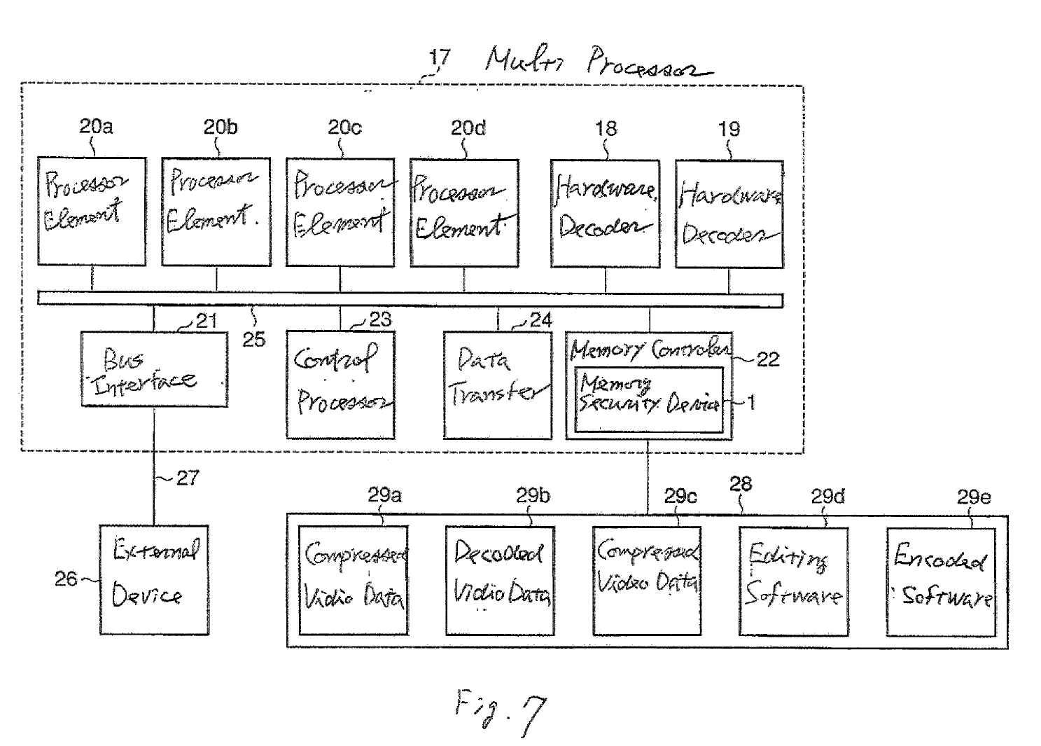

FIG. 7 is a block diagram showing an example of the multi-processor provided with the memory security device 1 according to the present embodiment.

A multi-processor 17 decodes (or expands) compressed video data by use of its hardware because fixed formats used for the decoding (or expansion) are large in number. On the other hand, the multi-processor 17 encodes the video data by use of flexible software through programmable processor elements (for example, DSPs, which stands for digital signal processors) in order that the current format of the video data can be converted to formats corresponding to various devices.

The multi-processor 17 has a configuration in which a hardware decoder 18, a hardware decoder 19, multiple processor elements (for example, SPEs, which stands for Synergistic Processor Elements) 20a to 20d, a high-speed general-purpose bus interface (for example, PCIe I/F, which stands for Peripheral Component Interconnect Express Interface) 21 such as PCI Express, a memory controller 22, a control processor (for example, SCP, which stands for System Control Processor) 23, and a data transferer (for example, DMAC, which stands for Direct Memory Access Controller) 24 are connected together via an internal bus (for example, Interconnect Network) 25.

The general-purpose bus interface 21 transfers and receives data to and from the external device 26, via the bus 27.

The memory controller (or memory interface) 22 is connected to the hardware decoders 18 and 19 as well as a memory 28 used by the multiple processor elements 20a to 20d.

This memory controller 22 corresponds to the device 10 according to the first embodiment, and includes the memory security device 1.

Compressed video data 29a received by the multi-processor 17, video data 29b obtained by decoding the compressed video data 29a, compressed video data 29c obtained by editing and compressing the video data 29b, editing software 29d, and encoding software 29e are stored in the memory 28.

The control processor 23 is a processor that controls the hardware decoders 18 and 19, the multiple processor elements 20a to 20d, the data transferer 24, and the like.

The data transferer 24 transfers data between the general-purpose bus interface 21 and the memory controller 22.

The hardware decoder 18 is configured of a set of hardware, and decodes data which is compressed in a first format (for example, mpeg-2/mpeg-1).

The hardware decoder 19 is configured of another set of hardware, and decodes data which is compressed in a second format (for example, H.264/VCI).

The multiple processor elements 20a to 20d are designed to be capable of operating in parallel in accordance with control from the control processor 23. At least one of the multiple processor elements 20a to 20d executes the editing software 29d in the memory 28 in accordance with control from the controller processor 23, and thereby creates edited data.

In addition, at least another of the multiple processor elements 20a to 20d executes the encoding software 29e in the memory 28 in accordance with control from the controller processor 23, and thereby encodes various data such as the decoded video data 29b and the edited data.

In the present embodiment, the descriptions are provided for the case where the four processor elements 20a to 20d are included in the multi-processor 17. It should be noted, however, that the number of processor elements included in the multi-processor 17 can be changed freely as long as the number is two or more.

Specifically, in the multi-processor 17, decoding operations are carried out by the hardware decoder 18 or the hardware decoder 19, each being a set of hardware, and encoding operations are carried out by the encoding software 29e that runs on at least one of the processor elements 20a to 20d.

In the case of the present embodiment, the compressed video data 29a is decoded exclusively by the hardware decoder 18 or the hardware decoder 19, each being a set of hardware. That is because the resolution and the number of formats of each set of video data is uniformly determined depending on what standards (for example, terrestrial digital TV broadcasting, BS Hi-vision TV broadcasting which is a nickname of a high-definition satellite digital TV broadcasting service provided by Japan Broadcasting Corporation, HD-DVD (high-definition digital versatile disc) or Blu-ray DVD) is used when the set of video data is recorded. In general, a chip occupying a smaller area can be achieved by a configuration which causes particular processes to be carried out by use of some sets of hardware.

A wide range of devices are used to playback compressed video data. Examples of the devices include cellular phones, portable video players, DVD recorders, game consoles, and computer systems. No single standard resolution or format is determined for such a wide range of devices for playing back compressed video data. In many cases, manufacturers freely determine what resolution and format are used for their products. For this reason, the multi-processor 17 according to the present embodiment is designed to cause each set of video data to be encoded by one of the processor elements 20a to 20d by use of the encoding software 29e for the purpose of flexibly encoding the set of video data depending on what player is used to play back the set of video.

The encoding software 29e is updatable. Accordingly, even if a standard of a player for playing back compressed video or an encode standard is changed, the multi-processor 17 according to the present embodiment is capable of coping with the standard change.

Descriptions will be provided for a first to fourth phases of the process carried out by the multi-processor 17 having the foregoing configuration.

First Phase: The control processor 23 controls the data transferer 24. The data transferer 24 transfers, to the memory controller 22 via the internal bus 25, a set of compressed video data (or compressed video stream) 29a, which is received by the general-purpose bus interface 21 from the external device 26 via the bus 27. The memory controller 22 causes the memory security device 1 to shuffle the contents and storage location of the compressed video data 29a, and stores the shuffled contents and storage location of the compressed video data 29a in the memory 28.

Second Phase: The control processor 23 controls either the hardware decoder 18 or the hardware decoder 19. The hardware decoder 18 or 19 controlled by the control processor 23 acquires the compressed video data 29a stored in the memory 28, via the memory controller 22 and the internal bus 25. When reading the compressed video data 29a from the memory 28, the memory controller 22 causes the memory security device 1 to convert the read address, and concurrently to decrypt the compressed video data 29a, which is an object to be read, and which is encrypted.

The hardware decoder 18 or 19 controlled by the control processor 23 stores the decoded video data 29b obtained by decoding the compressed video data 29a in the memory 28 via the internal bus 25 and the memory controller 22. At this time, the memory controller 22 causes the memory security device 1 to shuffle the contents and storage location of the decoded video data 29b, and then stores the shuffled contents and storage location of the decoded video data 29b in the memory 28.

Third Phase: The control processor 23 controls at least one of the multiple processor elements 20a to 20d (in this case, processor elements 20a to 20d are included in the multi-processor 17). At least one processor element, which is controlled by the controller processor 23, accesses, via the memory controller 22 and the internal bus 25, the editing software 29d and the encoding software 29e, which are stored in the memory 28, and concurrently acquires the decoded video data 29b stored in the memory 28. When reading the editing software 29d, the encoding software 29e, and the decoded video data 29b from the memory 28, the memory controller 22 causes the memory security device 1 to convert the read address, and concurrently to decrypt the editing software 29d, the encoding software 29e, and the decoded video data 29b, which are objects to be read, and which are encrypted.

At least one processor element, which is controlled by the control processor 23, edits the decoded video data 29b through an operation based on the editing software 29d, and subsequently encodes the resultant edited data through an operation based on the encoding software 29e. Thereafter, the compressed video data 29c obtained by this encoding is stored in the memory 28 via the internal bus 25 and the memory controller 22. At this time, the memory controller 22 causes the memory security device 1 to shuffle the contents and storage location of the compressed video data 29c, and stores the shuffled contents and storage location of the compressed video data 29c in the memory 28. It should be noted that a single processor element may execute both the editing software 29d and the encoding software 29e, and that two processor elements may respectively execute the editing software 29d and the encoding software 29e.

Fourth Phase: The control processor 23 controls the data transferer 24. The transferer 24 transfers the compressed video data 29c stored in the memory 28, to the general-purpose bus interface 21 via the memory controller 22 and the internal bus 25. The general-purpose bus interface 21 transmits the compressed video data 29c to the external device 26 via the bus 27. When reading the compressed video data 29c from the memory 28, the memory controller 22 causes the memory security device 1 to convert the read address, and concurrently to decrypt the compressed video data 29c, which is an object to be read, and which is encrypted.

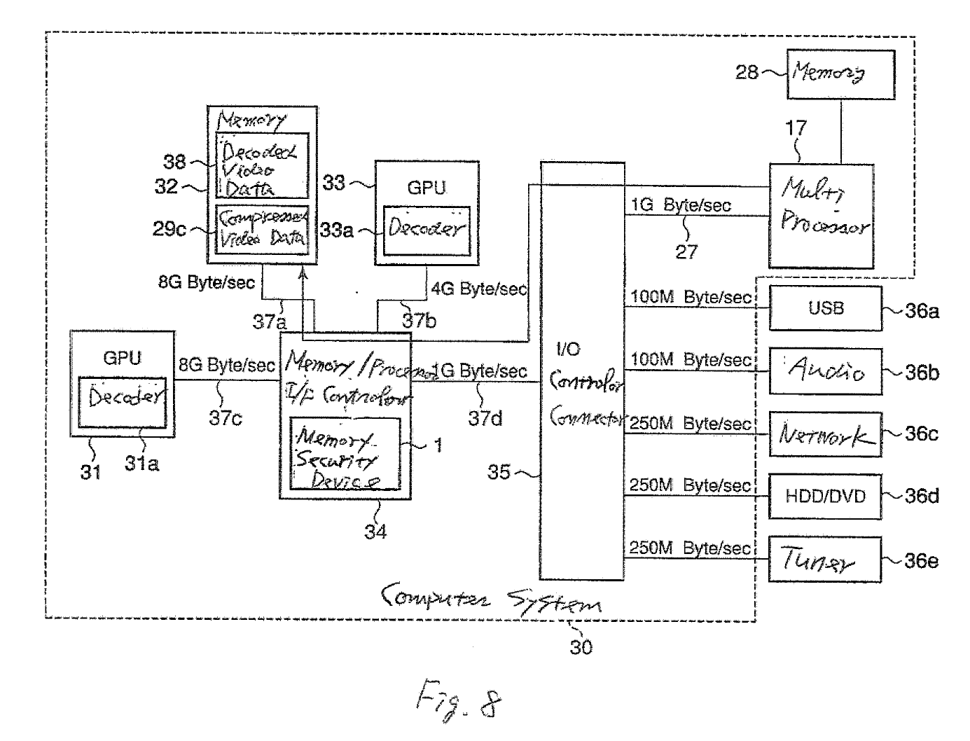

FIG. 8 is a block diagram showing an example of an application of the multi-processor 17 according to the present embodiment. FIG. 8 illustrates a case where the multi-processor 17 is included in a computer system 30.

In the present embodiment, the computer system 30 includes a CPU (central processing unit) 31, a memory 32, a GPU (graphics processing unit) 33, a memory/processor control connector 34, an I/O (input/output) control connector 35, the multi-processor 17, and the memory 28.

The computer system 30 acquires data from a USB (universal serial bus) 36a, an audio device 36b, a network 36c, a HDD (hard disc drive) or DVD 36d, or a tuner 36e, and presents data to the USB 36a, the audio device 36b, the network 36c, or the HDD or DVD 36d.

The memory/processor control connector 34 and the memory 32 are connected to each other by use of a bus 37a with a bandwidth (or transfer rate) of, for example, 8 GBytes/sec.

The memory/processor control connector 34 and the GPU 33 are connected to each other by use of a bus 37b with a bandwidth of, for example, 4 GBytes/sec.

The memory/processor control connector 34 and the CPU 31 are connected to each other by use of a bus 37c with a bandwidth of, for example, 8 GBytes/sec.

The memory/processor control connector 34 and the I/O control connector 35 are connected to each other by use of a bus 37d with a bandwidth of, for example, 1 GByte/sec.

The I/O control connector 35 and the multi-processor 17 are connected to each other by use of the bus 27 with a bandwidth of, for example, 1 GByte/sec.

Data is transferred with a bandwidth of, for example, 100 MBytes/sec between the I/O control connector 35 and the USB 36a, and between the I/O control connector 35 and the audio device 36b.

Data is transferred with a bandwidth of, for example, 250 MBytes/sec between the I/O control connector 35 and the network 36c, between the I/O control connector 35 and the HDD or DVD 36d, and between the I/O control connector 35 and the tuner 36e.

The I/O control connector 35 is a chip for connecting the various devices 36a to 36e to the other components in the computer system 30.

The memory/processor control connector 34 connects the memory 32, the CPU 31, the GPU 33 and the I/O control connector 35 to one another.

The memory/processor control connector 34 includes the memory security device 1 according to the present embodiment, and uses the memory security device 1 while writing data in the memory 32, and while reading data from the memory 32.

Descriptions will be provided hereinbelow for how the computer system 30 operates.

The I/O control connector 35 receives the compressed video data 29a from one of the USB 36a, the audio device 36b, the network 36c, the HDD or DVD 36d, and the tuner 36e, and then transfers the compressed video data 29a to the multi-processor 17 via the bus 27.

Upon reception of the compressed video data 20a, the multi-processor 17 causes its internal hardware to decode the compressed video data 29a, performs a necessary editing process on the resultant decoded video data by use of the editing software 29d, and then encodes the resultant edited video data by use of the encoding software 29e. Thereby, the multi-processor 17 creates the compressed video data 29c in a format which the computer system 30 handles. After that, the multi-processor 17 transfers the compressed video data 29c to the I/O control connector 35 via the bus 27. In a case where the multi-processor 17 uses the memory 28, the memory security device 1 included in the multi-processor 17 is used.

The I/O control connector 35 transfers the compressed video data 29c to the memory/processor control connector 34 via the bus 37d.

The memory/processor control connector 34 transfers the compressed video data 29c to one of the CPU 31, the memory 32, and the GPU 33 via a corresponding one of the buses 37a to 37c.

When the CPU 31 receives the compressed video data 29c, the CPU 31 decodes the compressed video data 29c by use of its decoding function 31a. Thereafter, the CPU 31 stores a decoded video data 38 in the memory 32 via the bus 37c, the memory/processor control connector 34, and the bus 37a. When the memory/processor control connector 34 writes the decoded video data 38 in the memory 32, the memory security device 1 included in the memory/processor control connector 34 is used.

When the GPU 33 receives the compressed video data 29c, the GPU 33 decodes the compressed video data 29c by use of its decoding function 33a. Thereafter, the GPU 33 performs a process for outputting the decoded video data 38.

It should be noted that the GPU 33 may be designed to store the decoded video data 38 in the memory 32 via the bus 37b, the memory/processor control connector 34, and the bus 37a. In this case, the memory/processor control connector 34 stores the decoded video data 38 in the memory 32 by use of the memory security device 1. In addition, the GPU 33 may be designed to output the video data 38 which is decoded by the CPU 31.

The compressed video data 29c, or the decoded video data 38 obtained by decoding the compressed video data 29c as well as software used in the CPU 31, the GPU 33, and the like is stored in the memory 32. The contents and their storage locations in the memory 32 are beforehand shuffled by the memory security device 1 in the memory/processor control connector 34.

On the other hand, the I/O control connector 35 receives the compressed video data from one of the CPU 31, the memory 32, and the GPU 33 via a corresponding one of the buses 37a to 37c, the memory/processor control connector 34, and the bus 37d. Thereafter, the I/O control connector 35 transfers the compressed video data thus received to the multi-processor 17 via the bus 27.

Upon reception of the compressed video data, the multi-processor 17 decodes the compressed video data in its inside, performs a necessary editing process on the decoded video data, and recompresses the resultant edited video data, thereafter transferring the compressed video data to the I/O control connector 35 via the bus 27. When the multi-processor 17 uses the memory 28, the memory security device 1 included in the multi-processor 17 is used.

The I/O control connector 35 outputs this compressed video data to one of the USB 36a, the audio device 36b, the network 36c, and the HDD or DVD 36d.

It should be noted that uncompressed data may be transferred either from one of the CPU 31, the memory 32, and the GPU 33 to the multi-processor 17, or from the multi-processor 17 to one of the CPU 31, the memory 32 and the GPU 33.

In this computer system 30, as described above, the bandwidth used for the data transfer between the CPU 31 and the memory/processor control connector 34, between the memory 32 and the memory/processor control connector 34, and between the GPU 33 and the memory/processor control connector 34 is either 8 GBytes/sec, or 4 GBytes/sec.

By contrast, the bandwidth used for the data transfer between the memory/processor control connector 34 and the I/O control processor 35 and between the I/O control connector 35 and the multi-processor 17 is 1 GByte/sec.

In other words, the bandwidths used for the data transfer between the CPU 31 and the memory/processor control connector 34, between the memory 32 and the memory/processor control connector 34, and between the GPU 33 and the memory/processor control connector 34 are designed to be wider than the bandwidth used for the data transfer between the memory/processor control connector 34 and the I/O control processor 35 and between the I/O control connector 35 and the multi-processor 17.

Assume a case where, for example, a set of video data is transferred in a channel from the I/O control connector 35, the bus 37d, the memory/processor control connector 34, and the bus 39a to the memory 32. The bus 37d has the bandwidth of 1 GByte/sec, but all of the bandwidth of 1 GByte/sec can not be used for the transfer of this set of video data in the bus 37d between the memory/processor control connector 34 and the I/O control connector 35. That is because, while this set of video data is being transferred in the bus 37d, the bus 37 has to allow another set of data to be transferred between the memory processor control connector 34 and the I/O control connector 35. In general, if a bandwidth is restricted while a set of video data is being transferred, the restriction makes it difficult to secure the real time quality for the set of data in some cases.

In the case of the present embodiment, however, the video data 29c is designed to be transferred in a compressed state through the bus 37d between the memory/processor control connector 34 and the I/O control connector 35. Accordingly, the bandwidth of the bus 37d can be efficiently used, and the compressed video data 29c can thus be transferred through the bus 37d while the bus 37 affords to allow other sets of data to be transferred therethrough. As a result, the present embodiment is capable of securing the real time quality for any set of video data even if the set of video data is large in data size.

In other words, in the case of the present embodiment, a set of video data is designed to be transferred in a compressed state through the bus 37d in the computer system 30. As a result, even if multiple sets of data surge into the bus 37d, the present embodiment is capable of transferring the multiple sets of data through the bus 37d with the real time quality being secured for all of the multiple sets of data.

Descriptions will be provided for concrete effects brought about by the foregoing scheme. For example, a bandwidth needed to transfer a set of data complying with the conventional standards of the NTSC (National Television System Committee) is approximately 15 Mbytes/sec, which is obtained by calculating 320 (width)×240 (height)×3 (colors)×60 (frames/second). However, when a set of video data complying with the standards for the Hi-vision TV broadcasting is intended to be transferred, the data transfer requires a bandwidth of approximately 180 Mbytes/sec, which is obtained by calculating 1920 (bytes/frame/color for width)×1080 (bytes/frame/color for height)×3 (colors)×60 (frames/second). As a result, the bus needs to have a bandwidth of approximately 360 Mbytes/sec to allow the bus to transfer a set of video data complying with the standards for the High-vision TV broadcasting in one direction and another set of video data in the other direction. In practice, information for system control also needs to be transferred through the same bus. For this reason, the bus is required to have an even larger bandwidth.

For example, neither a bus with one slot complying with a first standard requiring a 133-Mbytes/sec bandwidth nor a bus with a slot complying with a second standard requiring a 250-Mbytes/sec bandwidth has a bandwidth large enough for a set of video data, with the above-mentioned data size, complying with the standards for the High-vision TV broadcasting to be transferred uncompressed through the bus.

For example, a bus with four slots each complying with the second standard has a bandwidth of a total of 1 GBytes/sec. However, this bus is still incapable of transferring the set of video data by full use of the 1-GBytes/sec bandwidth, because the data transfer efficiency is normally 60% to 75%, and because other sets of data are transferred through the bus at the same time.

By contrast, in the case of the computer system 30 including the multi-processor 17 according to the present embodiment, as described above, a set of video data is transferred while compressed in a format corresponding to the computer system 30. This transfer scheme makes it possible to output even a large-volume set of data, such as a set of video data complying with the standards for the High-vision TV broadcasting, with the real time quality being secured for the output.

In the case of the multi-processor 17 according to the present embodiment, at least one of the multiple processors elements 20a to 20d is designed to generate the compressed video data 29c by decoding and editing the compressed video data 29a. It should be noted, however, that the multiple processor element may be designed not to carry out editing process and only to carry out a transcodec process for converting a compressed set of video data in a format to the compressed set of video data in another format, for example, converting data which has been compressed using MPEG-2 to the data compressed using H.264.

In the case of the present embodiment, examples of the editing process include a process for extracting a highlight scene from a sports event or a specific segment from a news program by use of an image processing technology and an audio processing technology. In this case, the editing process is a process for extracting, for example, data on a specific scene which is repeated more than a predetermined number of times, data on a specific scene where the sound volume increases, data with a specific characteristic, video data on a specific person identified by use of a face cognition technology, and the like. These data are extracted from a set of video data on the basis of points at which the sound volume drastically changes, points at which the sound pauses, texts included in the set of video data, and the like.

In addition, the editing process may be a process for converting a set of video data in the current format to a set of video data in a format corresponding to the output device, such as changing the number of pixels, resolution, and the like.

Furthermore, the editing process may be a process used for implementing a user interface in which, for example, an input is controlled on the basis of a user's gestures included in a set of video data by extracting characteristic points from the set of video data.

In the case of the present embodiment, a fixed process (a process complying with the standards which are less likely to be changed, or are changed less often) are carried out by hardware. Examples of the fixed process include: decoding a compressed set of video data complying with the standards for the terrestrial digital broadcasting; decoding a compressed set of video data complying with the standards for the High-vision TV broadcasting; and decoding a compressed set of video data stored in a storage medium such as a DVD or hard disc.

In the case of the present embodiment, by contrast, a process whose essential contents are fixed, but whose parts varies depending on intended use, is carried out by any one of the processor elements 20a to 20d by use of software. Examples of such a process include a process in which an encoding is carried out in accordance with fixed parts of the process contents, but in which the rest of the process contents are variable depending on an output destination. Specifically, examples of processes carried out based on the software by the processor elements are: a process of encoding a set of video data in the H.294 format, and subsequently storing the resultant compressed set of video data, for example, in a HDD, otherwise in a HD or DVD; a process of encoding a set of video data in the MPEG-2 format, and subsequently storing the resultant compressed set of video data, for example, in a DVD; a process of changing the current bit rate to a bit rate corresponding to the MPEG-2 format for the purpose of reducing the volume of a set of video data; and a process of encoding a set of video data in the MPEG-4 format, and subsequently storing the resultant compressed set of video data, for example, in a portable game device or a portable music player.

Similarly, the editing processes including the face recognitions process, the characteristic point extracting process, the audio recognition process, and the texts (or characters) recognition process are executed by any one of the processor elements by use of the software.

The multi-processor 17 has no video output function, and uses a chip set function. Neither a texture unit nor a rasterizer for processing computer graphics is installed in this multi-processor 17. This makes the chip area occupied by the multi-processor 17 smaller than the chip area occupied by the GPU. Use of the multi-processor 17 makes it unnecessary that the GPU should be used for the transcodec, and accordingly makes it possible to cause the GPU to carry out its original processes. As a result, it is possible to increase the cost-effectiveness of the chip.

In the case of the present embodiment, an encrypting device is included in each of the memory controller 22 for controlling the external memory chip 28 and the memory/processor control connector 34 for controlling the external memory chip 32. The address and data are encrypted by each encrypting device. The memory controller 22 is designed to shuffle the address and the set of data which are requested by the external memory chip 28, and to communicate the shuffled address and the shuffled set of data with the memory chip 28. The memory/processor control connector 34 is designed to shuffle the address and the set of data which are requested by the external memory chip 32, and to communicate the shuffled address and the shuffled set of data with the external memory chip 32. Thereby, it is possible to protect the contents of any set of data from an unauthorized data acquisition and a data manipulation, even in a case where the unauthorized data acquisition and the data manipulation are attempted on either of the external memory chips 28 and 32. That is because a set of data obtained through any one of the unauthorized data acquisition and the data manipulation is turned into a meaningless set of data by the foregoing shuffling scheme.

### Third Embodiment

As a third embodiment, a modification of the multi-processor 17 according to the second embodiment will be described.

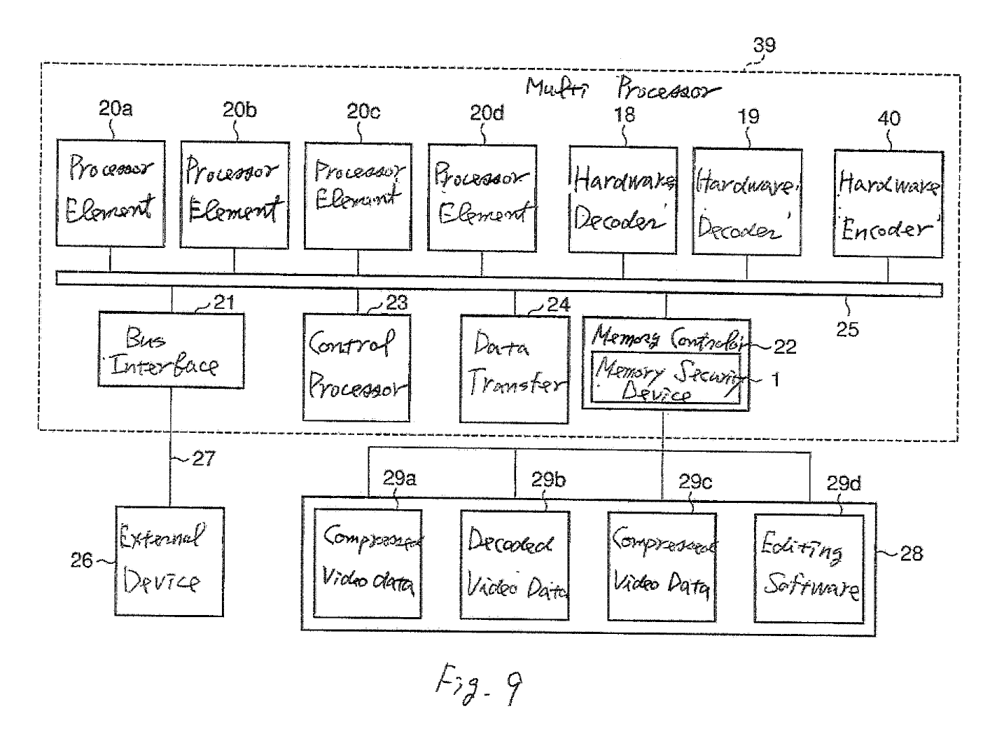

FIG. 9 is a block diagram showing an example of a multi-processor provided with a memory security device according to the present embodiment.

A multi-processor 39 has almost the same configuration as the multi-processor 17 shown in FIG. 7, except that the multi-processor 39 further includes a hardware encoder 40.

From the reception of the compressed video data 29a by the general-purpose bus interface 21 through the storage of the decoded video data 29b in the memory 28, the multi-processor 39 carries out the same operation as the multi-processor 17 according to the second embodiment.

In the multi-processor 39, the control processor 23 controls at least one of the processor elements 20a to 20d. At least one processor element thus controlled by the control processor 23 accesses the editing software 29d stored in the memory 28, and concurrently acquires the decoded video data 29b stored in the memory 28, as well as edits the decoded video data 29b through its operation based on the editing software 29d, thus transferring the resultant edited data to the hardware encoder 40.

Subsequently, the control processor 23 controls the hardware encoder 40. The hardware encoder 40 encodes the edited data, and stores, in the memory 28, the compressed video data 29c, which is obtained by the encoding operation.

Thereafter, the control processor 23 controls the data transferer 24. The data transferer 24 transmits the compressed video data 29c, which is stored in the memory 28, to the external device via the general-purpose bus interface 21.

The above-described multi-processor 39 according to the present embodiment is designed to cause its hardware to carry out the encoding operation in addition to the decoding operation. Use of the multi-processor 39 according to the present embodiment brings about the same effect as use of the multi-processor 17 according to the second embodiment. The multi-processor 39 is suitable for a case where the encoding operation, in addition to the decoding operation, is carried out in a fixed manner. As a result, the multi-processor 39 is capable of increasing the process rate.

The foregoing descriptions have been provided for the embodiments citing the cases where the type of data handled by the multi-processors 17 and 39 as well as the computer system 30 is video data. It should be noted, however, that the embodiments are similarly applicable to data of types other than video data.

In addition, the multi-processors 17 and 39 may also be included, for example, in an appliance such as a DVD recorder, instead of being applied to the computer system 30 such as a personal computer.

The multi-processors 17 and 39 according to the embodiments may be designed to once store the edited data in the memory, to thereafter access the edited data stored in the memory, and to encode the edited data.

In the case of the multi-processors 17 and 39, the operations carried out respectively by the control processor 23, the data transferer 24, and the memory security device 1 may be designed to be implemented by the processor elements.

What is claimed is:

1. A semiconductor device having a memory security block, the memory security block comprising:
an address encryption section operable to encrypt a write address or a read address;
a data encrypting section operable to encrypt data to be written;
a write section operable to write encrypted data at an encrypted write address corresponding to a memory;
a read section operable to read encrypted data from the encrypted read address corresponding to the memory; and
a data decryption section operable to decrypt the read encrypted data to obtain read data corresponding to the read address.

2. The semiconductor device as recited in claim 1, further comprising:
a random number generating section; and
a random number storing section for storing a random number generated by the random number generating section, wherein the address encryption section encrypts the write address or the read address based on the stored random number, the data encryption section encrypts the data to be written based on the stored random number, and the date decryption section decrypts the read encrypted data based on the stored random number.

3. The semiconductor device as recited in claim 2, wherein
the address encryption section encrypts the write address by performing an operation between the write address and the stored random number and encrypts the read address by performing the operation between the read address and the stored random number,
the data encrypting section encrypts the data to be written by performing the operation between the data and the stored random number, and
the data decrypting section decrypts the read encrypted data by performing the operation between the read encrypted data and the stored random number.

4. The semiconductor device as recited in claim 3, wherein the operation is an exclusive OR (XOR).

5. The semiconductor device as recited in claim 1, further comprising:
a random number generating section; and
a random number storing section for storing a first random number and a second random number, wherein both the first random number and the second random number are generated by the random number generating section, the first random number and the second random number are distinct, the address encryption section encrypts the write address or the read address based on the stored first random number, the data encryption section encrypts the data to be written based on the stored second random number and the date decryption section decrypts the read encrypted data based on the stored second random number.

6. The semiconductor device as recited in claim 5, wherein the random number generates the first random number and the second random number when the memory security logic is activated or a reset instruction is received.

7. A method of protecting the contents of a memory, comprising:
if data is to be written:
encrypting a write address corresponding to a memory;
encrypting the data to be written; and
writing the encrypted data at the encrypted write address in the memory; and
if data is to be read:
encrypting a read address corresponding to the memory;
reading the encrypted data from the encrypted read address corresponding to the memory; and
decrypting the read encrypted data to obtain read data corresponding to the read address.

8. The method as recited in claim 7, further comprising:
generating a random number; and
storing the random number, wherein the write address and the read address is encrypted based on the stored random number, the write data is encrypted based on the stored random number, and the read encrypted data is decrypted based on the stored random number.

9. The method as recited in claim 8, wherein the write address is encrypted by performing an operation between the write address and the stored random number, the read address is encrypted by performing the operation between the read address and the stored random number, the data to be written is encrypted by performing the operation between the data and the stored random number, and read encrypted data is decrypted by performing the operation between the read encrypted data and the stored random number.

10. The method as recited in claim 9, wherein the operation is an exclusive OR (XOR).

11. The method as recited in claim 7, further comprising:
generating a first random number and a second number, wherein the first random number and the second random number are distinct; and
storing the first random number and the second random number, wherein the write address and the read address are encrypted based on the stored first random number, the write data is encrypted based on the stored second random number and the read encrypted data is decrypted based on the stored second random number.

12. The method as recited in claim 11, wherein the first random number and the second random number are generated when the memory security logic is activated or a reset instruction is received.

13. A computer system for use with digital television, comprising:
a multi-processor unit operable to decode compressed first data, generate second data from the first data and encode the second data to generate compressed second data;
a memory/processor controller operable to receive third data and store the third data in a first memory, the memory/processor controller having a memory security block, the memory security block comprising:
an address encryption section operable to encrypt a write address or a read address;
a data encrypting section operable to encrypt data to be written;
a write section operable to write encrypted data at an encrypted write address corresponding to the first memory;
a read section operable to read encrypted data from the encrypted read address corresponding to the first memory; and
a data decryption section operable to decrypt the read encrypted data to obtain read data corresponding to the read address;
a central processing unit coupled to the memory/processor controller; and
an I/O unit coupled to one or more devices and operable to receive data from the one or more devices, a multi-processor unit and a memory/processor controller and communicate data to the one or more devices, the multi-processor unit and the memory/processor controller.

14. The computer system as recited in claim 13, wherein the first data is compressed in a first format and the second data is compressed in a second format different than the first format.

15. The computer system as recited in claim 14, wherein the second data is generated by editing the first data.

16. The computer system as recited in claim 14, wherein the second data is generated using a transcodec process

17. The computer system as recited in claim 13, wherein the computing system comprises a second memory and the multi-processor unit comprises a second memory security block comprising:
an address encryption section operable to encrypt a write address or a read address;
a data encrypting section operable to encrypt data to be written;
a write section operable to write encrypted data at an encrypted write address corresponding to the second memory;
a read section operable to read encrypted data from the encrypted read address corresponding to the memory; and
a data decryption section operable to decrypt the read encrypted data to obtain read data corresponding to the read address.

18. The computer system as recited in claim 17, wherein the multi-processor unit comprises multiple processor elements and a control processor.

19. The computer system as recited in claim 18, wherein the multi-processor unit comprises a hardware decoder and a hardware encoder.

20. The computer system as recited in claim 13, wherein the one or more devices comprise a USB, an audio device, a network, a HDD, a DVD or a tuner.
